(19) United States
(12) Patent Application Publication
(10) Pub. No.: US 2003/0028891 A1
(43) Pub. Date: Feb. 6, 2003

(54) System and method for diagnosing RF signal strength at a set-top terminal

(75) Inventors: Charles Hardt, Lawrenceville, GA (US); Zhentao Mao, Duluth, GA (US)

Correspondence Address: RADER FISHMAN & GRAUER PLLC, LION BUILDING, 1233 20TH STREET N.W., SUITE 501, WASHINGTON, DC, 20036, US

(73) Assignee: General Instrument Corporation

(21) Appl. No.: 09/920,767

(22) Filed: Aug. 3, 2001

(51) Int. Cl. H04N 7/173; H04N 7/16; H04J 1/00

(52) U.S. Cl. 725/107; 725/140; 370/486

(57) ABSTRACT

A system and method for diagnosing RF signal strength at a set-top terminal includes a network characterization diagnostic tool, such as a diagnostic application routine, that is loaded into the flash memory of the set-top terminal. An installation technician or field service engineer invokes the diagnostic application routine by entering a pseudo secret key sequence into the set-top terminal. Then, the diagnostic application routine measures the RF signal strength for the entire bandwidth and produces a visual display of a plot of the signal strengths on a television set operatively coupled to the set-top terminal. The display allows the installation technician or field service engineer to easily diagnose whether a “hole” or “tilt” exists in the measurement of the RF signal strength.

### BACKGROUND OF THE INVENTION

1. Field of the Invention

This invention generally relates to cable television (CATV) communication systems, and in particular to a CATV set-top terminal that includes a network characteristic diagnostic tool for diagnosing RF signal strength at the set-top terminal.

2. Description of the Related Art

The CATV transmission spectrum typically comprises a bandwidth of are frequencies up to 1000 MHz. During transmission of signals over the CATV network between the headend and the set-top terminals, the higher frequencies experience greater attenuation than the lower frequencies. To compensate for the unequal attenuation, CATV network operators install devices throughout the CATV network to periodically equalize and amplify the signals as they are transmitted over the network. However, once the signal is output from the last active component in the transmission network, such as a line amplifier, no compensation for the unequal attenuation is provided. When line extenders are introduced or when a subscriber is located a long distance from the tap, large inequalities develop between the strength of signals at lower frequencies and those at higher frequencies. This degrades the performance of the RF tuner.

A second problem that reduces the performance of the RF tuner is the introduction of second and higher order distortions caused by the plurality of input carrier frequencies. As CATV network operators offer more channels over their networks, the bandwidth of the CATV network continues to expand. This results in an increase in the number of input carrier frequencies, which further degrades the performance of the RF tuner due to second and higher order distortions.

A video information user or subscriber is typically authorized access to specific CATV channels by subscribing to and paying for CATV services. Accordingly, when the video information user does not receive a channel that they are authorized to receive, the CATV network operator typically receives a complaint from an irate user. Unless the problem is a system-wide failure, the CATV network operator will not know the exact cause of the problem until a technician is dispatched to assess and to correct the problem. This increases user frustration and dissatisfaction with the CATV network provider.

Typically, the technician would swap out the set-top terminal with another unit if a set-top terminal appears to operate incorrectly due to a variety of problems associated with the set-top terminal. One such problem may be the degradation of RF signal strength of one or more carrier frequencies. In some cases, the swap out of the set-top terminal appears to correct the problem and the set-top terminal that was swapped out is correctly returned to the service center for repair. However, in many cases, the service center would find no fault with the set-top terminal that was returned for service and the set-top terminal was incorrectly swapped out because the technician incorrectly diagnosed the problem due to RF signal degradation with the set-top terminal.

One way to correctly diagnose the problem of RF signal strength degradation by the installation technician is to equip the technician with a spectrum analyzer. Unfortunately, the spectrum analyzer is relatively expensive and the cost associated with such a spectrum analyzer prohibits its widespread use by the installation technician or field service engineer.

The inventors have recognized this problem and have developed a network characterization diagnostic tool that can be loaded into the flash memory of the set-top terminal to enable the installation technician to correctly and inexpensively diagnose problems associated with the set-top terminal and the general health of the CATV network.

### SUMMARY OF THE INVENTION

The invention comprises a system and method for diagnosing RF signal strength at a set-top terminal. A network characterization diagnostic tool, such as a diagnostic application routine, is part of the core code that is loaded into the flash memory of the set-top terminal. The diagnostic application routine is intended to be used only by an installation technician or field service engineer by invoking a pseudo secret key sequence. Once the proper key sequence has been entered (via the set-top terminal front panel keyboard), the set-top terminal control is transferred from the user application to the diagnostic application. The diagnostic application routine then opens a graphics port on the television of the video information user. The graphics port (or window) will become the primary method of displaying diagnostic information to the installation technician or field service engineer.

When the network characterization diagnostic tool is invoked, the diagnostic application routine clears the current graphics port and draws a chart using the Cartesian coordinate system. Then, the diagnostic application routine causes the tuner of the set-top terminal to move to the base (or lowest supported) frequency. The set-top terminal hardware is then used to determine the relative signal strength of any signal at the currently tuned frequency. If valid data is available, the diagnostic application routine plots the relative signal strength on the chart displayed on the television of the video information user. The diagnostic application routine causes the tuner of the set-top terminal to move to the next frequency index, for example, an index of 6 Mhz, and the acquisition sequence and plot update are repeated. The acquisition sequence and plot update continue until the maximum range of the tuner is reached. As part of post processing by the diagnostic application routine, any Out of Band (OOB) carrier frequencies are graphically identified as well as any Data Over Cable System Integration Specification (DOCSIS) carrier frequencies.

By using the diagnostic application routine, the information obtained from the network characterization diagnostic tool allows the installation technician or field service engineer to determine not only the valid carrier frequencies, but also the relative strength of the carrier frequencies. In addition, the diagnostic application routine allows the installation technician or field service engineer to determine the general health of a cable operators' network by observing a “tilt” or a “hole” in the carrier frequencies.

### BRIEF DESCRIPTION OF THE DRAWINGS

In the drawings:

FIG. 1 is a block diagram of an end-to-end cable television communication network embodying the present invention;

FIG. 2 is a simplified block diagram of the communication path between a subscriber and the headend;

FIG. 3 is the preferred embodiment of the set-top terminal of the present invention;

FIG. 4 shows a flowchart of the method for diagnosing RF signal strength at the set-top terminal according to the invention; and

FIG. 5 is a plot of carrier frequency as a function of RF signal strength according to the system and method of the invention.

### DESCRIPTION OF THE PREFERRED EMBODIMENT

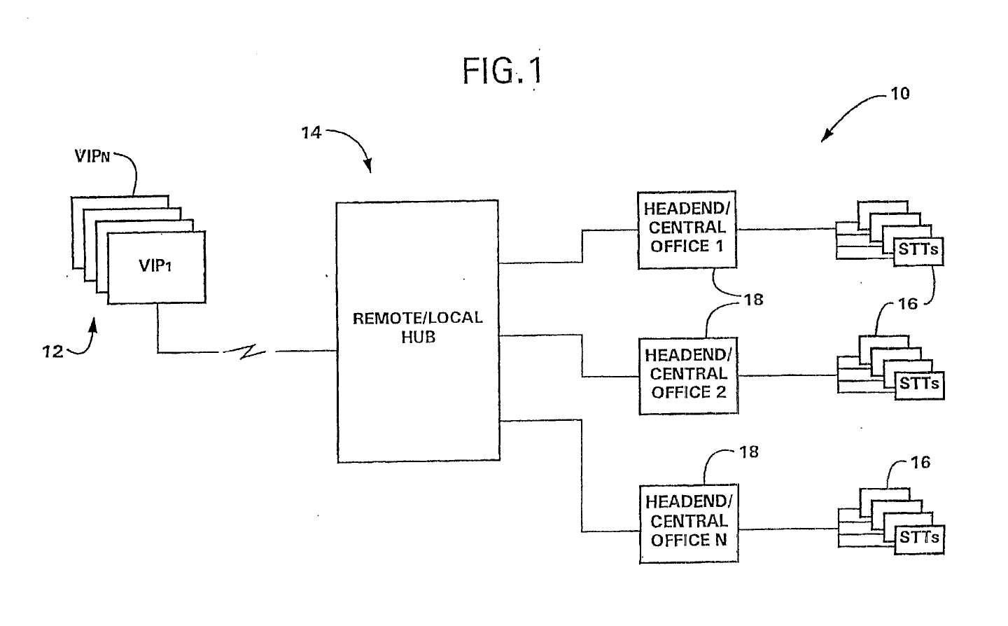

A CATV communication network 10 embodying the present invention is shown in FIG. 1. The communication network 10 generally comprises a remote/local hub 14 that communicates with a plurality of headends/central office 18, each of which in turn communicate with a plurality of set-top terminals (STTs) 16. The STTs 16 are the interface between the television of a video information user (VIU) and the communication network 10. The remote/local hub 14 may be physically located remote from the headends 18 or, alternatively, may be located at the site of any one of the headends 18. The communication network 10 interfaces with a plurality of video information providers (VIPs) 12 that provide compressed digital video and services. Through the remote hub 14 and the headends 18, the communication network 10 provides two-way transparent (protocol stack independence, layer 3-7) data transport service between the VIPs 12 and the video information users at the STTs 16. The hub 14 provides broadcast information services from the VIPs 12 to all STTs 16 on the network 10. The headends 18 facilitate interactive communications between the VIPs 12 and the STTs 16 that are served by that particular headend 18. In the preferred embodiment of the invention, communications between the VIPs 12, the remote/local hub 14 and the headend/central offices 18 are transmitted over a fiber optic medium.

To provide the bi-directional communication flow over the network 10, the frequency spectrum of the physical medium from the headend 18 to the STTs 16 is divided into a downstream signal path originating at the headend 18 and an upstream signal path originating at the STTs 16. The bandwidth of the physical medium in the preferred embodiment extends up to 1 GHz. The downstream bandwidth typically employs frequencies above 50 MHz, and the upstream frequencies below 50 MHz. The downstream and upstream bandwidths are further divided into 6 MHz channels. In the present invention, a portion of the 6 MHz channels is allocated for analog communications and the remainder for digital communications. Accordingly, analog and digital communications may be frequency division multiplexed (FDM) over the separate channels and transported over the same physical medium. Analog CATV communication systems are well known in the art, such as the system disclosed in U.S. Pat. No. 4,533,948, (to McNamara et al.) and in U.S. Pat. No. 4,245,245, (to Matsomoto et al.), the entire contents of which are herein incorporated by reference.

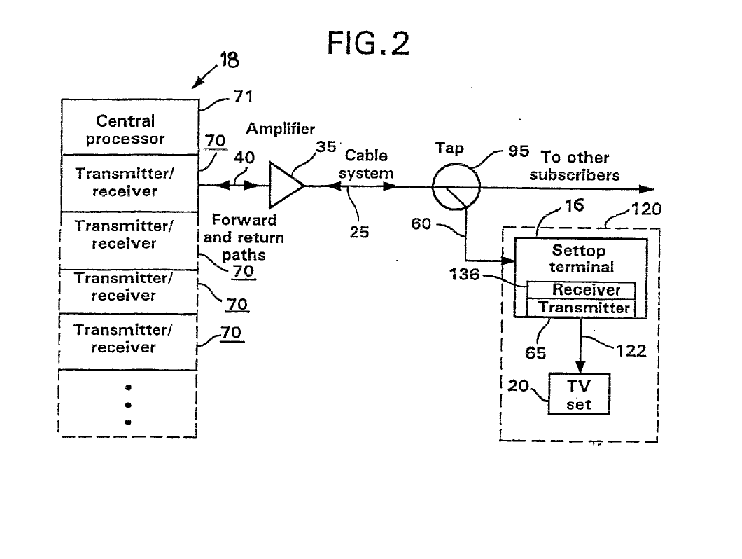

A simplified block diagram of the communication path between a subscriber and the headend 18 is shown in FIG. 2. The transmitter/receivers 70 (transceivers) transmit analog and/or digital video, audio and data signals from the headend 18 to a subscribers' installation 120 which typically comprises the set-top terminal 16 and a television 20, or a VCR (not shown). The plurality of transceivers 70 at the headend 18 transmits programming on a plurality of CATV broadcast channels as assigned by the CATV network operator. Additionally, a dedicated data-only channel is provided over a control data channel (CDC). A combiner (not shown) combines the plurality of channels for transmission over the CATV network 10. The headend 18 also includes a central processor 71 that generates all communications originated at the headend 18 and receives all incoming messages from subscribers. The central processor 71 may transmit messages to the subscribers in several ways. First, the CDC may be used to transmit address data to a plurality of subscribers or to only one subscriber as is well known in the art. Additionally, the central processor 71 may insert data on an available line of the vertical blanking interval (VBI) of a television signal on any CATV broadcast channel.

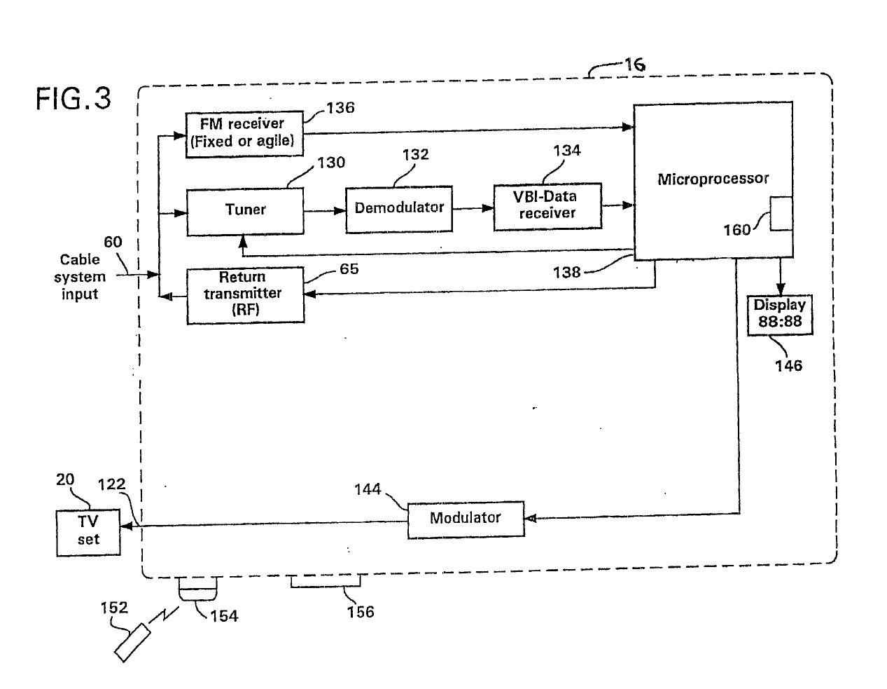

Referring to FIG. 3, the preferred embodiment of the set-top terminal 16 of the present invention is shown. A subscriber utilizes the CATV set-top terminal 16 to tune to a desired channel and view the selected programming via the television set 20. The set-top terminal 16 receives an input signal from the CATV dropline 60. A tuner 130 receives the carrier frequency and tunes to the channel desired by the subscriber. A demodulator 132 and a VBI data receiver 134 extract the VBI data from the analog audio and video (A/V) signals. The analog A/V signals are then forwarded by a microprocessor 138 to a modulator 144 which places the A/V signals on a selected RF carrier frequency, typically television channel 3 or 4, for input to the television set 20. To store binary data and executable programs, the microprocessor 138 includes a memory 160 of a type well known in the art, such as a random-access memory (RAM), read-only memory (ROM), flash memory, and the like.

An FM receiver 136, which may be fixed or agile, is tuned to the CDC which transmits data originating at the headend 18. This data typically includes addressable data streams and other data sent from the CATV network operator to the subscribers. A detailed explanation of the function of the CDC, which is well known to those skilled in the art, is outside the scope of this description. As in conventional CATV set-top terminals, an LED or LCD display 146 indicates the channel to which the subscriber is currently tuned. In the present invention, the display 146 also enables the CATV network operator to provide messages and other information to the subscriber as will be described in detail hereinafter. The set-top terminal 16 may be controlled via an infrared IR transmitter 152 and receiver 154, or via a plurality of push-button keys 156, keyboard (not shown) or any other type of input device may be used.

The set-top terminal 16 may include an RF preprocessing section (not shown) for accepting the entire RF input spectrum and preprocessing a select bandwidth of the spectrum and tune to a carrier frequency corresponding to the channel selected by the consumer. An example of such an RF preprocessing section is described in U.S. Pat. No. 6,014,547, the entire contents of which is herein incorporated by reference.

The RF spectrum transmitted over the CATV transmission network 10 is a wideband RF signal, extending from approximately 50 to 1,000 Mhz. As the wideband signal is transmitted from the headend 18 to the plurality of set-top terminals 16, the frequencies at the lower end of the spectrum will experience different propagation loss rates than the frequencies at the higher end of spectrum. At the input to a set-top terminal 16, therefore, the signal level of the lower frequencies may be much greater than the higher frequencies.

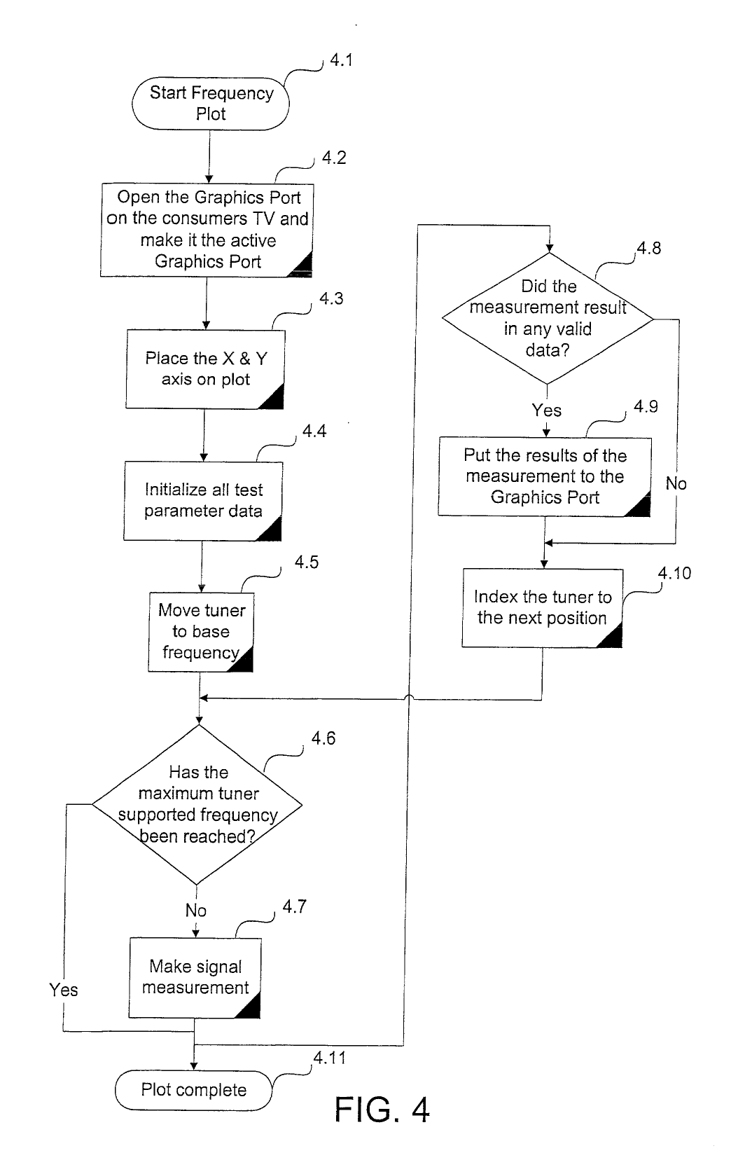

Referring now to FIG. 4, a method of the invention utilizing a network characterization diagnostic tool, such as a diagnostic application routine, for diagnosing the RF signal strength at the set-top terminal 16 will now be described. The method begins with the installation technician or field service engineer invoking the diagnostic application routine loaded into the memory 160 of the microprocessor 138 at the set-top terminal 16 in Step 4.1. One way the diagnostic application routine may be invoked is by entering a pseudo secret key sequence via the push-button keys 156 of the set-top terminal 16.

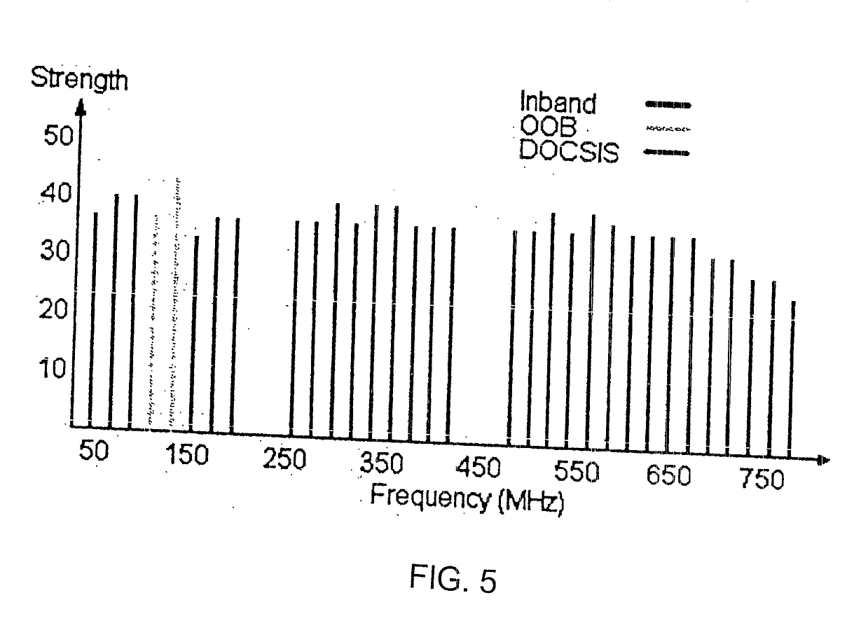

After the diagnostic application routine has been invoked, a graphic port on the television set 20 is opened in Step 4.2. The diagnostic application routine places the graphics port on top of all other open ports and makes it the active graphics port. Next, the axis for a graph of carrier frequency as a function of strength is produced on the television set 20 using the Cartesian coordinate system in Step 4.3, as shown in FIG. 5. Then, all the test parameter data is initialized in Step 4.4. Then, the diagnostic application routine moves the tuner 130 of the STT 16 to the base carrier frequency or the lowest supported carrier frequency, for example 50 Mhz, in Step 4.5. It will be appreciated that the invention is not limited by the base carrier frequency, and that the invention can be practiced with any desired base carrier frequency for the SST 16.

After the tuner 130 of the STT 16 is moved to the base carrier frequency, the diagnostic application routine determines whether the maximum carrier frequency has been reached in Step 4.6. If the maximum carrier frequency has not been reached, then the diagnostic application routine makes a measurement of the signal strength of the carrier frequency in Step 4.7. Then, the diagnostic application routine determines whether the measurement of the signal strength of the carrier frequency results in a valid measurement of the data in Step 4.8. The measurement is considered a valid measurement when a carrier is detected at the selected frequency.

If the measurement of the signal strength is valid, then the diagnostic application routine produces a plot of the results to the graphics port for displaying to the installation technician or service engineer on the television set 20 in Step 4.9, as shown in FIG. 5. Next, the diagnostic application routine indexes the tuner 130 of the STT 16 to the next carrier frequency, for example by incrementing the previously measured carrier frequency by 6 Mhz in Step 4.10. The indexing of the tuner 130 may be predetermined from a list of valid carrier frequencies defined by the cable provider. If the measurement of the signal strength of the carrier frequency is not valid in Step 4.8, then the plot of the signal strength is not produced and the diagnostic application routine proceeds to Step 4.10.

Next, the diagnostic application routine continues in a loop and proceeds to Step 4.6 until measurements of the signal strength of the carrier frequency is performed across the entire bandwidth of the RF input spectrum. If the diagnostic application routine determines that the maximum carrier frequency, for example about 756 Mhz, has been reached, then the plot of carrier frequency as a function of signal strength is complete and the routine ends in Step 4.11. It will be appreciated that the invention is not limited by the maximum carrier frequency, and that the invention can be practiced with any desired maximum carrier frequency.

Once the plot of carrier frequency as a function of RF signal strength is complete, the installation technician of field service engineer can easily diagnose whether RF signal strength degradation has occurred at the set-top terminal 16 by visual observation of the plot on the television set 20. In addition to the RF signal strength for Inband carrier frequencies, the diagnostic application routine can indicate an Out of Band (OOB) carrier frequency and a Data Over Cable System Integration Specification (DOCSIS) carrier frequency as a different color than the Inband carrier frequency, as shown in FIG. 5. Thus, the installation technician or field service engineer can easily diagnose whether any OOBs and DOCSISs exist at the STT 16 by visual observation of the color of the RF signal strength for each carrier frequency.

In addition, the installation technician or field service engineer can easily observe whether the measurement was valid or invalid at one or more carrier frequencies because a “hole” will exist where the measurement was invalid and not plotted. As shown in FIG. 5, a “hole” exists at a carrier frequency of about 450 Mhz. Further, the installation technician or field service engineer can easily observe the measured signal strength for the entire bandwidth to diagnose whether a slope or “tilt” exists in the CATV network 10.

As described above, the present invention provides a system and method for diagnosing the RF signal strength at the set-top terminal 16. The information provided by the diagnostic application routine of the invention allows the installation technician or field service engineer to not only easily determine the RF signal strength at each carrier frequency, but also the general health of the CATV network 10.

While the invention has been specifically described in connection with certain specific embodiments thereof, it is to be understood that this is by way of illustration and not of limitation, and the scope of the appended claims should be construed as broadly as the prior art will permit.

What is claimed is:

1. A CATV communication network, comprising:
a local/remote hub for communicating with at least one headend/central office; and
at least one set-top terminal for receiving a CATV signal comprising a plurality of channels over a transmission bandwidth from the at least one headend/central office, the at least one set-top terminal including a microprocessor having a memory, a diagnostic application routine stored in the memory that determines a signal strength for a plurality of carrier frequencies of the bandwidth and produces a visual indication of the signal strength for the plurality of carrier frequencies of the bandwidth.

2. The communication network according to claim 1, wherein the visual indication comprises a plot of carrier frequency as a function of signal strength.

3. The communication network according to claim 2, wherein the plot provides an indication of one of Inband, Out of Band, and Data Over Cable System Integration Specification carrier frequency.

4. The communication network according to claim 1, further comprising display means for displaying the visual indication produced by the diagnostic application routine.

5. The communication network according to claim 4, wherein the display means comprises a television set operatively coupled to the at least one set-top terminal.

6. A set-top terminal for receiving a CATV signal comprising a plurality of channels over a transmission bandwidth, the set-top terminal comprising:
a microprocessor having a memory;
a diagnostic application routine stored in the memory of the microprocessor that determines a signal strength for a plurality of carrier frequencies of the bandwidth and produces a visual indication of the signal strength for the plurality of carrier frequencies of the bandwidth.

7. The set-top terminal according to claim 6, wherein the visual indication comprises a plot of carrier frequency as a function of signal strength.

8. The set-top terminal according to claim 7, wherein the plot provides an indication of one of Inband, Out of Band, and Data Over Cable System Integration Specification carrier frequency.

9. The set-top terminal according to claim 6, further comprising display means for displaying the visual indication produced by the diagnostic application routine.

10. The set-top terminal according to claim 9, wherein the display means comprises a television set operatively coupled to the set-top terminal.

11. A method for diagnosing RF signal strength at a set-top terminal, comprising the steps of:
receiving a CATV signal comprising a plurality of channels over a transmission bandwidth;
determining a signal strength for a plurality of carrier frequencies of the bandwidth by utilizing a diagnostic application routine stored in a memory of the set-top terminal; and
producing a visual indication of the signal strength for the plurality of carrier frequencies of the bandwidth.

12. The method according to claim 11, wherein the visual indication comprises a plot of carrier frequency as a function of signal strength.

13. The method according to claim 12, wherein the plot provides an indication of one of Inband, Out of Band, and Data Over Cable System Integration Specification carrier frequency.

14. The method according to claim 11, further comprising the step of displaying the visual indication produced by the diagnostic application routine on a display means.

15. The method according to claim 14, wherein the display means comprises a television set operatively coupled to the set-top terminal.

16. The method according to claim 11, further comprising the step of invoking the diagnostic application routine by entering a pseudo secret key sequence into the set-top terminal.

17. The method according to claim 11, further comprising the step of determining whether a selected carrier frequency is a valid carrier frequency.

18. The method according to claim 11, wherein the signal strength of the carrier frequency is performed across an entire bandwidth of an RF input spectrum.
